(19) United States
(12) Patent Application Publication
(10) Pub. No.: US 2015/0371259 A1
(43) Pub. Date: Dec. 24, 2015

(54) LOCAL ANALYTICS

(71) Applicant: Ping WU, Saratoga, CA (US)

(72) Inventor: Ping WU, Saratoga, CA (US)

(21) Appl. No.: 13/307,907

(22) Filed: Nov. 30, 2011

(51) Int. Cl. G06Q 30/02

(52) U.S. Cl. CPC G06Q 30/0252

(57) ABSTRACT

Merchant related event data is extracted from advertising and social system logs. Advertising events are linked with corresponding social events. The extracted merchant related event data is aggregated based on an event-type and location. The aggregated event data is then filtered, for example based on a reference time period, and visually displayed to an advertiser via an interactive event metric tool. The advertiser may utilize the event metric tool to interactively evaluate the effectiveness of digital advertising in the physical world.

### BACKGROUND

This disclosure relates to content presentation, and more particularly to methods and systems for performance reporting of content presentation campaigns.

With the expanding commercialization of the Internet and Internet capable mobile devices, Internet-based advertising continues to increase. Internet advertising, like other more traditional forms of advertising, serves multiple purposes including commercial, charitable, educational, and entertainment purposes. Online or digital advertising can take multiple forms, for example, text, video, audio, images, and/or any combination thereof.

The effectiveness of this type of advertising can be measured in various ways. However, conventional measuring systems are centered around metrics for the digital world, for example, providing detailed website metrics for analyzing the effectiveness of advertising campaigns on online user traffic. Local businesses and/or advertisers who utilize online advertising to drive foot traffic into their respective stores currently do not have means to easily and quickly map the effectiveness of their campaigns to customer foot traffic.

### SUMMARY

This specification describes technologies relating to content presentation in general, and specifically to methods and systems for presenting content presentation campaign performance data.

In general, one aspect of the subject matter described in this specification can be embodied in a computer-implemented method comprising: obtaining merchant related event information from advertising and social system logs, where merchant related events are advertising or social events associated with a merchant; determining whether any obtained merchant related social events occurred within a predetermined time period of any obtained merchant related advertising events; and for those social events determined to have occurred within the predetermined time period, linking the social event to the advertising event if both events are associated with a common customer. In addition, the obtained merchant related event information may be aggregated on the basis of event type, location, and time period, filtered based on predefined criteria selected by a merchant via an interactive user interface tool, and visually displayed via the interactive user interface tool.

These and other embodiments can optionally include one or more of the following features. The merchant related events may be presentation of an ad, clickthrough of an ad, conversion of an ad, check-in at a merchant, and/or recommending of a merchant. In addition, the visually displaying the filtered aggregated merchant related event data may include transmitting a graphical representation of the aggregated event information for display to the merchant, the graphical representation including a geographic map and a visual representation on corresponding areas of the geographic map indicating where merchant related events occurred during the reference time period. The visual representation may be a regional color distinction for regions where merchant related events have occurred, where each distinct color represents a numerical range of the merchant related events. Alternatively, the visual represent may be one or more icons positioned at corresponding locations on the geographic map where a representative merchant related event occurred and the shape of the icon represents the type or sub-category of the merchant related event which occurred at the corresponding location.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram of an exemplary content presentation system.

FIG. 2 is a block diagram of an exemplary advertising management server.

FIGS. 3A-B are flow diagrams of exemplary methods for obtaining, aggregating and filtering merchant related advertising and social event data.

FIGS. 4A-C are exemplary illustrations of an event metric tool interface.

FIG. 5 is a block diagram illustrating an exemplary computing device.

### DETAILED DESCRIPTION

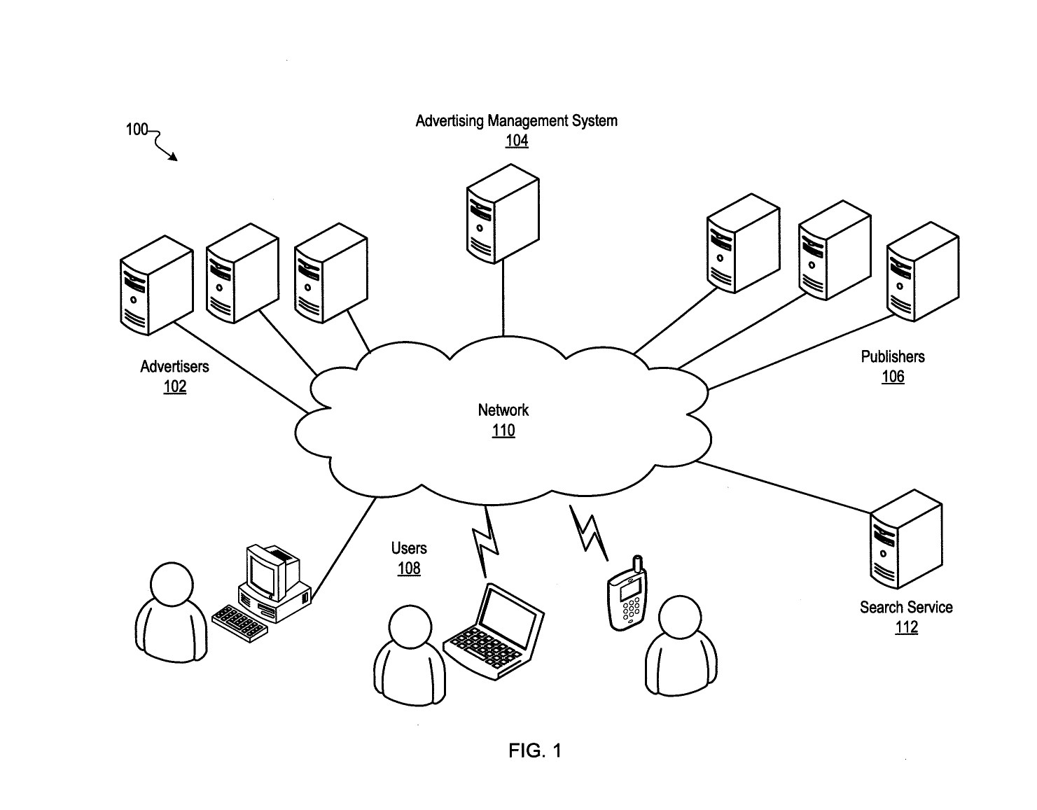

FIG. 1 is a block diagram of an exemplary content presentation system 100. The content presentation system can include large numbers of advertisers 102, publishers 106, user devices 108, and a search engine 110. Although reference is made to advertisements, other forms of content including other forms of sponsored content can be provided in the content presentation system 100.

Advertisers 102 can directly, or indirectly, enter, maintain, and log ad information in the advertising management system 104. The ads can be in the form of graphical ads, such as banner ads, text only ads, image ads, barcode ads (i.e., ads including one or more barcodes, for example, for use in redeeming the ads), audio ads, video ads, ads combining one or more of any of such components, and so on. The ads can also include embedded information, such as links, meta-information, and/or machine executable instructions.

One or more publishers 106 can submit requests for ads to the system 104. The advertising management system 104 responds by sending ads to the requesting publisher 106 for placement on, or in association with, one or more of the publisher's properties. Exemplary publisher properties can include web pages, applications, streaming video/audio platforms and the like. Although advertisers 102 and publishers 106 are shown separately in FIG. 1, they can be the same entity, i.e., an advertiser can also be a publisher and vice versa.

Other entities, such as users 108 and advertisers 102, can provide usage information to the advertising management system 104, for example, whether or not a conversion (e.g., a purchase or other interaction) or a click-through related to an ad (e.g., a user has selected an ad) has occurred. This usage information can include measured or observed user behavior related to ads that have been provided for presentation.

A network 110 connects the advertisers 102, the advertising management system 104, the publishers 106, the users 108, and the search service 112. Network 110 can be a local area network (LAN), wide area network (WAN), the Internet, one or more telephony networks, a cloud computing network, or a combination thereof.

An exemplary publisher 106 may include an application running on a user device, for example, a game running on a tablet or smart phone. The application can submit a request for an ad to advertising management system 104. The ad request can include various information for use by the advertising management system 104 in determining the ads to provide in response to the request. For example, the ad request can include the number of ads requested, information about the event which triggered the request, amount of ad space available for presenting/displaying the ad. In addition, the ad request can include various information about the device running the application.

Another exemplary publisher 106 is a general content server that receives requests for content (e.g., articles, discussion threads, music, video, graphics, search results, web page listings, information feeds, and so on), and retrieves the requested content in response to the request. The content server can submit a request for ads to an advertisement server in the advertising management system 104. The ad request can include the number of ads desired. The ad request can also include content request information. The content request information can include the content itself (e.g., page, video broadcast, radio show, or other type of content), a category corresponding to the content or the content request (e.g., arts, business, computers, arts-movies, arts-music, and so on), part or all of the content request, content age, content type (e.g., text, graphics, video, audio, mixed media, and so on), geo-location information, and so on.

Search service 112 can also submit a request for ads to the advertising management system 104. For example, ads can be requested for presentation along with the search results responsive to a received query. The request can include a number of ads desired. This number can depend on the search results, the amount of screen or page space occupied by the search results, the size and shape of the ads, and so on. The request for ads can also include the query (as entered or parsed), information based on the query (such as geo-location information, whether the query came from an affiliate and an identifier of such an affiliate), and/or information associated with, or based on, the search results.

In some implementations, the content server (or a client browser or the like) combines the requested content with one or more of the ads provided by the advertising management system 104. The combined content and ads can be served (e.g., sent) to the users 108 that requested the content for presentation in a viewer (e.g., an application on a mobile device). The content server can transmit information about the ads back to the advertisement server, including information describing how, when and/or where the ads are to be rendered (e.g., in hypertext markup language (HTML) or JavaScript™).

Search service 112 receives queries from a plurality of users 108. In response, the search service 112 retrieves relevant search results from an index of documents (e.g., from an index of web pages) and provides them to the requesting user. The search results identify resources responsive to the submitted query. Exemplary search results can include lists of web page titles, snippets of text extracted from those web pages, and hypertext links to those web pages, and can be grouped into a predetermined number (e.g., ten) of search results.

As noted above, the advertising management system 104 can collect usage information from advertisers 102, publishers 106, and/or users. This usage information can include measured or observed user behavior related to ads that have been served by the management system. A served ad is an ad that has been provided for presentation in response to a request for ad(s). In addition to logging information related to the ads it serves, the advertising management system 104 can also receive and/or access logged information from other backend systems, e.g., electronic “wallet” systems or “check-in” systems.

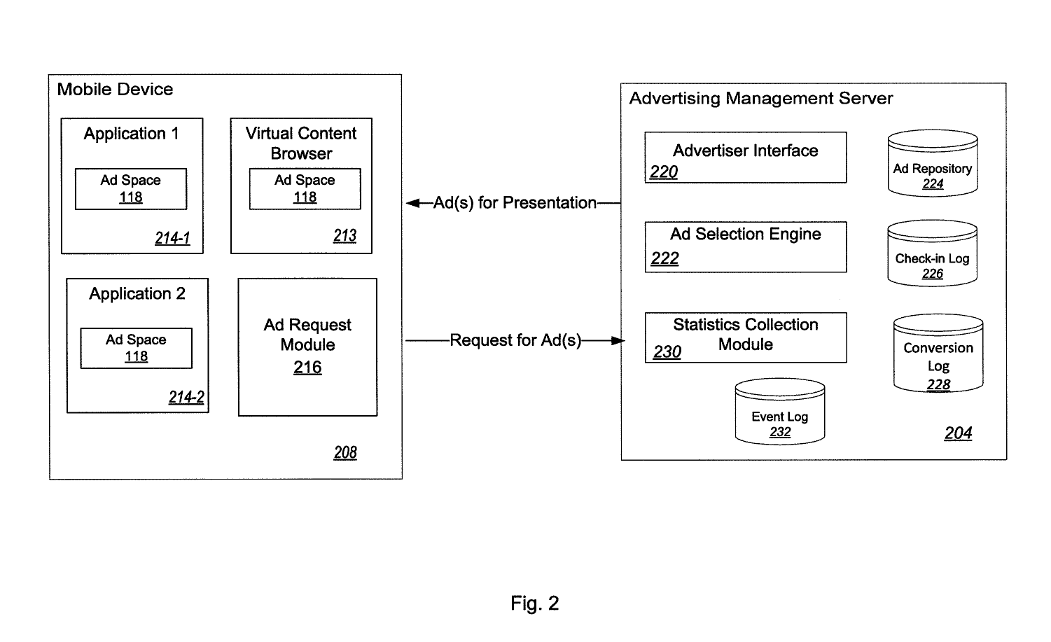

FIG. 2 is a block diagram of an exemplary advertising management server 204 operable to provide ads for presentation in response to a request for ad(s), for example from a mobile device 208. The mobile device 208 can include an ad request module 216. Although shown separately in FIG. 2, the ad request module 216 may be a part of virtual content browser 213 and/or a part of one or more application(s) 214-1, 214-2 stored on the device.

The ad request module 216 can be part of an application 214-1, 214-2 installed on the mobile device 208. The developer of the application has the ability to compile executable code into the application which upon one or more predefined events will submit a request for ads to the advertising management system 104. A broad range of triggerable events, conditions, user actions, and like may be predefined by the developer.

In addition to the information related to a particular ad request, various additional information regarding previously presented ads may be included in the ad request. For example, a request can include content focus duration information related to previously served ads (discussed in greater detail below). The additional information may be transmitted/provided to the advertising management system 104 via common gateway interface (CGI) parameters embedded in the ad request.

The ad server 204 includes an advertiser frontend interface 220 for creating advertisements and/or ad campaigns, ad repository 224 for storing ads, ad selection engine 222, statistics collection module 230, statistics log(s) 226, and conversion log(s) 228. The advertiser interface 220, ad selection engine 222, statistics collection module 230, ad repository 224, and statistics log 226 may be part of the advertising management server 204 as illustrated, or provided as independent components in communication with the advertising management server 204 in a manner known in the art. For example, advertising management server 204 may be provided as a distributed computing system.

Advertiser interface 220 provides an interface for advertisers 202 to create and manage ad campaigns. An ad campaign can be a simple of as a single creative with associated serving criteria or a plurality of creatives having related serving criteria. The serving criteria can include one or more parameters, provided by an advertiser or the advertising management system, indicating when, where and/or under what conditions particular creatives may be served. Using the advertiser interface 220, an advertiser can create a campaign by providing the content needed to present the different creatives and defining the serving criteria for the campaign. For example, the serving criteria parameters can include one or more of the following: one or more keywords or topics, geographic information, a value indication for the creative, start date, end date, and the like.

The advertiser interface 220 can include one or more tools to help an advertiser design a campaign and/or individual ad, also referred to as a creative. According to an exemplary embodiment, the advertiser interface 220 includes a metric tool which can be utilized by an advertiser or content providers to gauge ad and/or campaign quality.

According to an embodiment, the metric tool allows an advertiser to measure activity in the physical world based on campaigns/creatives presented in a digital world. The tool works with the advertising management server to provide core measurement functions to the advertiser. According to exemplary embodiments, the tool allows the advertiser to determine where and when their creatives are presented, where and when users interact with a presented creative, where and when users enter the advertisers physical store, and what percentage of users enter the advertiser's physical store after seeing or interacting with a creative. For example, local business owners whose primary goal is to drive foot traffic to their physical stores can utilize the event metric tool to visualize where and when their ads are being received and whether the served ads resulted in a conversion.

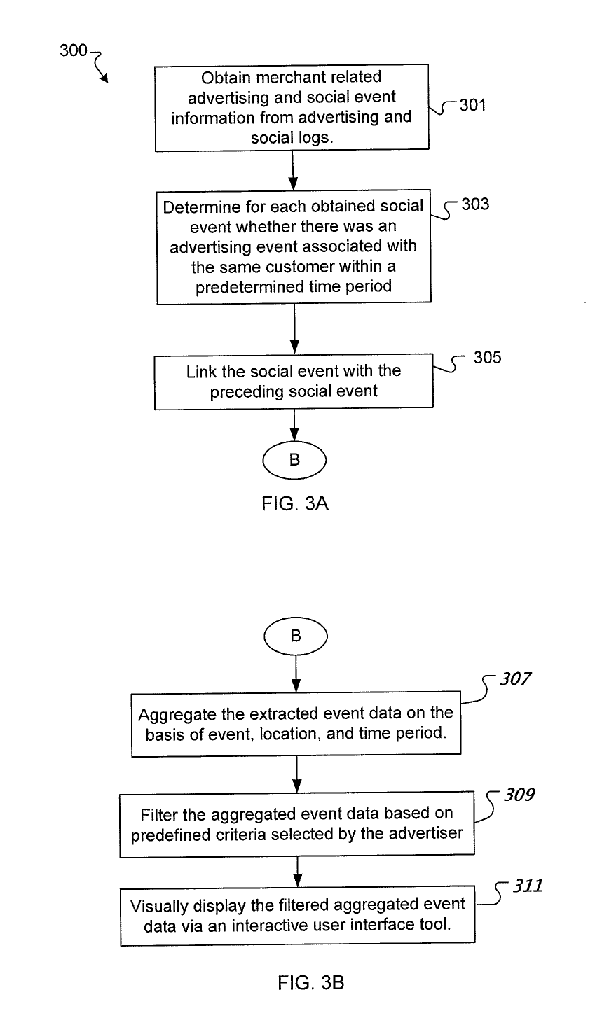

FIG. 3A is a flow diagram of an exemplary method for obtaining and linking merchant related events. Raw advertising and social event data is continuously logged in advertising and social logs, for example, in ad repository 224, check-in log 226, and conversion log 228 as events occur. Exemplary advertising events include serving an ad for presentation, also referred to as an impression, a click-through, and/or a conversion. These events can further be sub-categorized based on the platform and/or action taken. For example, impressions can be sub-categorized into mobile impressions, application impressions, and/or desktop impressions. Furthermore, click-throughs can be further categorized as click-to-chat, get driving directions, landing page, and the like. Finally, conversions can be sub-categorized into coupon redemption, online purchase, in-store purchase and the like. Exemplary social events include checking-in at a particular business or location, indicating a preference for a particular merchant/product, e.g., by “liking”, plus oneing +1 or becoming a fan, recommending a product or service, and/or rating a particular product, service, or location. Periodically, advertising and social event information associated with a merchant is extracted from the various logs and stored in event log 232 (step 301).

The extracted information includes the an indication of the type, such as impression, click-through, conversion, or check-in, location and time of the event, as well as supplemental information associated or linked with the event. The supplemental information varies based on the type of the triggering event and/or platform in which the event occurred. For example, events occurring on mobile devices may include additional information which is not available for events occurring on desktop platforms and vice versa. Conversion events may also include purchase details which would not be available for impressions and/or click-through type events. In addition, the extracted event information may be associated or linked together, where appropriate, based on common unique identifiers, e.g., participating user id or mobile device identification.

A determination is made whether any of the extracted social events occurred within a predetermined time period of an extracted advertising event. (Step 303). Social events which are preceded by one or more advertising events may be linked with the preceding advertising event. For example, if a customer check-ins a merchant location after receiving an ad for the merchant, the ad impression event and the check-in event can be linked to each other. The predetermined time period may be dynamically selected/determined by the merchant via an event metric tool and/or the time period can be selected/determined by the advertising system based on previously logged data and/or metrics. For those social events determined to have occurred within the predetermined time period, the social event is liked with the preceding advertising event, if both events are identified as being associated with a common customer (step 305). Advertising events can also be linked with other advertising event types, for example, impression or click-through events could be linked with conversion type events and the like.

FIG. 3B is a flow diagram of an exemplary method for aggregating and filtering extracted advertising and social events for access by the event metric tool. The extracted/logged advertising and social event information is aggregated on an event, time, and location basis (step 307). This process aggregates the logged data based on the event type, location of the event, and time of the event. For example, the number of impressions served in a predetermined region between 1:00 pm and 3:00 pm. The granularity of the data aggregation may vary as discussed below. The aggregated data is then stored for later access by the event metric tool.

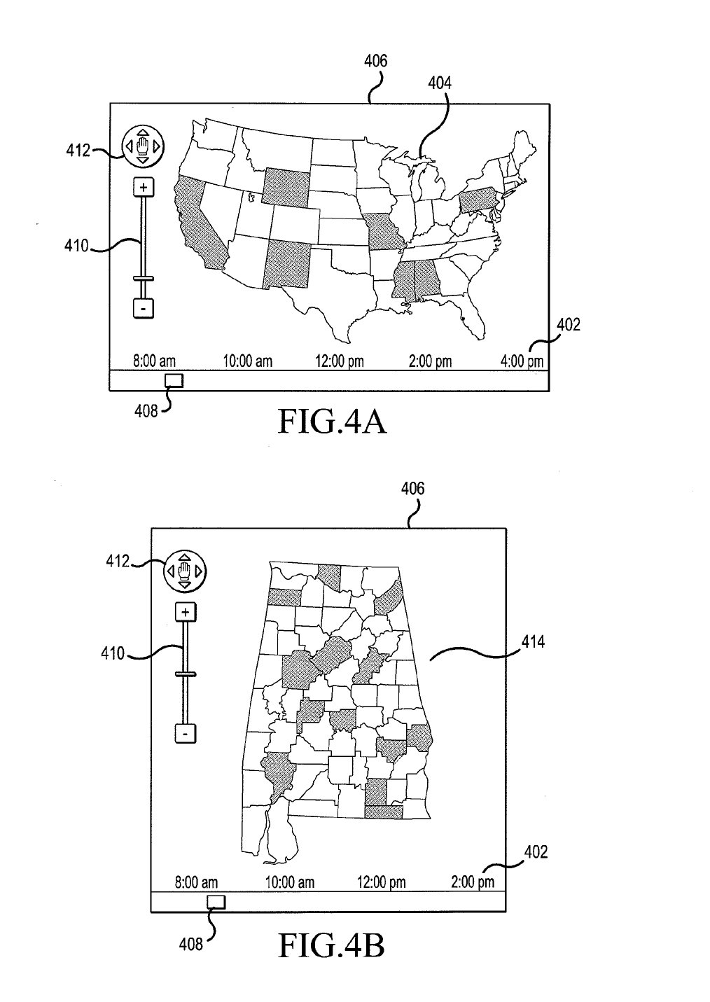

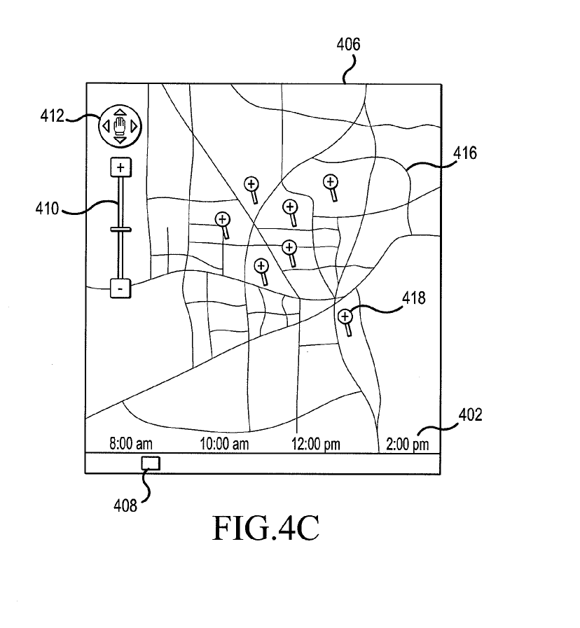

Filtering criteria are applied to the aggregated event data to produce a reduced data set (step 309). In most instances the primary filtering criteria is the advertiser requesting the data, e.g., the advertiser using the event metric tool. In addition to the advertiser, additional filtering criteria may be defined by the advertiser or the system to satisfy user or system requirements. The advertiser defined filtering criteria may include a selected time period, geographic region, event type, and/or a combination thereof. In addition, the user defined filtering criteria may be identified via user interface controls included in the event metric tool interface as discussed below with respect to FIGS. 4A-C. The filtered event data is visually displayed to the advertiser via the interactive event metric tool interface (step 311). In other instances, supplemental information associated with an event can be utilized to filter the event data. For example, price information associated with conversion events may be used to filter conversion event data and/or demographic information can be utilized to filter events based on gender and/or age.

As illustrated in FIGS. 4A-4C, according to an exemplary embodiment, the event metric tool interface visually displays the filtered aggregated event data based on the location and time period selected by the user. The interface includes a map window 406 which displays a geographic map 404 with a predefined level of granularity. The granularity of the geographic map can be varied by the user zooming in and/or out using the granularity control 410 and/or selecting, for example, by double-clicking, on select regions, if applicable, of the geographic map, such as shown in FIG. 4A or FIG. 4B. In addition, a user can selectively alter the focus of the geographic map by manipulating the focus control 412. Although FIGS. 4A-4C illustrate exemplary control elements, such as granularity control 410, other known multi-touch interactions, for example, finger swipes, flicks, pinches and like, may also be utilized for interaction on touch displays.

In addition to the geographic map 40, the interface includes a visual representation of the aggregated events associated with the advertiser. According to an exemplary embodiment, the visual representation is an overlay or visual alteration of the geographic map to indicate regions were event data has occurred. The visual alteration can be as simple as altering the color of appropriate regions to indicate a level or number of events which have occurred within the region during a selected time period. In other instances, the visual alteration includes altering the color of appropriate regions to indicate the intensity or amount of events occurring in the regions and also placing icons or symbols to reflect the type of events which have occurred. Any form of visual indication may be used to represent the number, type, and location of events which have occurred during a selected time period. In still other instances, once a user selects one or more regions on the map, a separate time-series chart, wherein the x-dimension represents time and the y-dimension or axis represents the events, is displayed on the side of the map or as a separate window.

The time period for filtering the aggregated event data can be set and/or altered by the user via any number of time reference controls. For example, the interface may include a time reference slide control 408 which allows the user to alter the desired time period. In other instances, the time reference may include a drop down menu, user input window, or some other form of user input interface for selecting or entering the desired time period.

According to an exemplary embodiment, the granularity of the visual representation is increased/decreased with the granularity of the geographic map. For example, as the geographic region displayed on the interface window decreases, e.g., from a state, to county, to city, to street, the visual representation may de-aggregate the event data down to potentially illustrating a single event. Although the interface may illustrate a single event, safe guards are put into place to prevent de-aggregating data beyond a predefined level if privacy concerns are at play. For example, if the location of an event corresponds to non-public locations such as a residence, safeguards are put into place to prevent de-aggregation of event data beyond a certain region granularity such a community or sub-division level. In some instances, a list of public areas with each area being represented by a polygon is maintained and any event located outside of a public area is considered a private event which cannot be shown below a certain level of granularity on the map. In other instances, each location of each logged event is “fuzzied” before aggregation. For example, instead of storing the actual coordinates of an event's location, the location can be stored as a circle with the centroid randomly selected around the original center.

The visual overlay can take many forms. In some instances, as shown in FIGS. 4A and 4B, the overlay is a color distinction or representation, where different colors may be utilized to distinguish those geographic locations where events have occurred. In other instances, as shown in FIG. 4C, icons 418 are utilized to indicate that one or more events has occurred in the geographic location of the icon. In still other instances, specific icons, such as push pins, may be positioned on the geographic map to indicate the location of the event. Furthermore, the color or shape of the icon may be altered to represent the type of event.

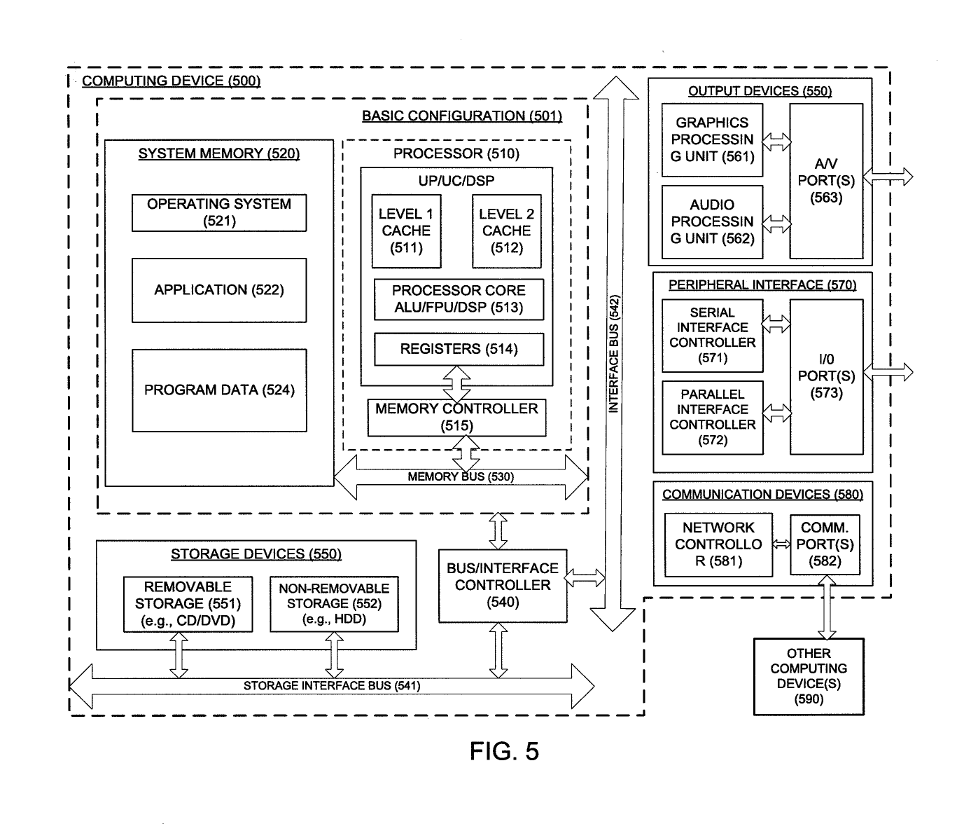

FIG. 5 is a block diagram illustrating an example computing device 500 that is arranged for performance reporting of content presentation campaigns in accordance with the present disclosure. In a very basic configuration 501, computing device 500 typically includes one or more processors 510 and system memory 520. A memory bus 530 can be used for communicating between the processor 510 and the system memory 520.

Depending on the desired configuration, processor 510 can be of any type including but not limited to a microprocessor (μP), a microcontroller (μC), a digital signal processor (DSP), or any combination thereof Processor 510 can include one more levels of caching, such as a level one cache 511 and a level two cache 512, a processor core 513, and registers 514. The processor core 513 can include an arithmetic logic unit (ALU), a floating point unit (FPU), a digital signal processing core (DSP Core), or any combination thereof A memory controller 515 can also be used with the processor 510, or in some implementations the memory controller 515 can be an internal part of the processor 510.

Depending on the desired configuration, the system memory 520 can be of any type including but not limited to volatile memory (such as RAM), non-volatile memory (such as ROM, flash memory, etc.) or any combination thereof. System memory 520 typically includes an operating system 521, one or more applications 522, and program data 524. This described basic configuration is illustrated in FIG. 5 by those components within dashed line 501.

Computing device 500 can have additional features or functionality, and additional interfaces to facilitate communications between the basic configuration 501 and any required devices and interfaces. For example, a bus/interface controller 540 can be used to facilitate communications between the basic configuration 501 and one or more data storage devices 550 via a storage interface bus 541. The data storage devices 550 can be removable storage devices 551, non-removable storage devices 552, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 520, removable storage 551 and non-removable storage 552 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media can be part of device 500.

Computing device 500 can also include an interface bus 542 for facilitating communication from various interface devices (e.g., output interfaces, peripheral interfaces, and communication interfaces) to the basic configuration 501 via the bus/interface controller 540. Example output devices 560 include a graphics processing unit 561 and an audio processing unit 562, which can be configured to communicate to various external devices such as a display or speakers via one or more A/V ports 563. Example peripheral interfaces 570 include a serial interface controller 571 or a parallel interface controller 572, which can be configured to communicate with external devices such as input devices (e.g., keyboard, mouse, pen, voice input device, touch input device, etc.) or other peripheral devices (e.g., printer, scanner, etc.) via one or more I/O ports 573. An example communication device 580 includes a network controller 581, which can be arranged to facilitate communications with one or more other computing devices 590 over a network communication via one or more communication ports 582. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 500 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method comprising:
obtaining merchant related event information from advertising and social system logs, where merchant related events are advertising or social events associated with a merchant;
identifying the obtained merchant related social events that occur within a predetermined time period of any obtained merchant related advertising events, where the predetermined time is selected by the merchant; and
for those social events identified as occurring within the predetermined time period, linking the identified social event to the advertising event if both events are associated with a common customer.

2. The method of claim 1, further comprising:
aggregating the obtained merchant related event information on the basis of event type, location, and time period;
filtering the aggregated merchant related event information based on predefined criteria selected by a merchant via an interactive user interface tool; and
visually displaying the filtered aggregated merchant related event information via the interactive user interface tool.

3. The method of claim 1, wherein the merchant related social event is a check-in at a merchant.

4. The method of claim 1, wherein the merchant related advertising event is presentation of an ad.

5. The method of claim 1, wherein the merchant related advertising event is a conversion.

6. The method of claim 1, wherein the merchant related advertising event is an ad clickthrough.

7. The method of claim 2, wherein visually displaying the filtered aggregated merchant related event data via the interactive user interface tool further comprises:
displaying a geographic map; and
displaying a visual representation on corresponding areas of the geographic map indicating where merchant related events occurred during a reference time period,
wherein the visual representation of the merchant related events depends in part on the selected time reference and granularity of the geographic map.

8. The method of claim 7, further comprising:
dividing areas where merchant related events have occurred into geographic regions; and
assigning a distinct color to each geographic region, each distinct color representing a numerical range of merchant related events.

9. The method of claim 8, further comprising:
assigning a distinct icon to each sub-category of occurred merchant related event; and
displaying the corresponding icon representing the various sub-categories of merchant related events having occurred within a region.

10. The method of claim 7, wherein the visual representation varies based on the granularity of the displayed geographic map.

11. The method of claim 1, wherein obtaining the merchant related event information from advertising and social system logs includes periodically extracting merchant related event information from advertising and social system logs.

12-15. (canceled)

16. A system comprising:
a database storing merchant related event information;
one or more processors configured to perform the steps of:
obtaining merchant related event information from advertising and social system logs, where merchant related events are advertising or social events associated with a merchant;
identifying the obtained merchant related social events that occur within a predetermined time period of any obtained merchant related advertising events, where the predetermined time period is determined by the merchant;
for those social events identified as occurring within the predetermined time period, linking the identified social event to the advertising event if both events are associated with a common customer;
aggregating the obtained merchant related event information on the basis of event type, location, and time period;
filtering the aggregated merchant related event information based on predefined criteria selected by a merchant via an interactive user interface tool; and
visually displaying the filtered aggregated merchant related event information via the interactive user interface tool.

17. The system of claim 16, wherein the merchant related advertising event is presentation of an ad.

18. The system of claim 16, wherein the merchant related advertising event is a conversion.

19. The system of claim 16, wherein the merchant related advertising event is an ad clickthrough.

20. The system of claim 16, wherein the merchant related social event is a check-in at a merchant.

21. The system of claim 16, wherein visually displaying the filtered aggregated merchant related event data via the interactive user interface tool further comprises:
displaying a geographic map; and
displaying a visual representation on corresponding areas of the geographic map indicating where merchant related events occurred during a reference time period,
wherein the visual representation of the merchant related events depends in part on the selected time reference and granularity of the geographic map.

22. The system of claim 21, further comprising:
dividing areas where merchant related events have occurred into geographic regions; and
assigning a distinct color to each geographic region, each distinct color representing a numerical range of merchant related events.

23. The system of claim 22, further comprising:
assigning a distinct icon to each sub-category of occurred merchant related event; and
displaying the corresponding icon representing the various sub-categories of merchant related events having occurred within a region.

24. The system of claim 21, wherein the visual representation varies based on the granularity of the displayed geographic map.

25. The system of claim 16, wherein obtaining the merchant related event information from advertising and social system logs includes periodically extracting merchant related event information from advertising and social system logs.
